(19) United States
(12) Patent Application Publication
(10) Pub. No.: US 2011/0011861 A1
(43) Pub. Date: Jan. 20, 2011

(54) Method, Device, Material Layer and Kit of Parts for Sealing a Drain

(75) Inventor: Geert Rita Erik Victor Nivelles, Hakendover (BE)

Correspondence Address: LERNER GREENBERG STEMER LLP, P O BOX 2480, HOLLYWOOD, FL, 33022-2480, US

(73) Assignee: ASSENTI-LUX S.A., Drinklange (LU)

(21) Appl. No.: 12/934,780

(22) PCT Filed: Mar. 27, 2009
(86) PCT No.: PCT/NL09/50152

§ 371 Date: Oct. 5, 2010

(30) Foreign Application Priority Data
Mar. 27, 2008 (NL) 2001410

(51) Int. Cl. B65D 35/44; B23P 11/00; B23P 19/00; B32B 3/10

(52) U.S. Cl. 220/200; 29/428; 29/700; 428/542.8; 428/195.1

(57) ABSTRACT

The invention relates to a method and device for sealing a drain of any dimension, form and depth in a floor of a sanitary space or other spaces. By making use of a firm or flexible material layer dimensioned for the purpose of sealing a drain and a preprocessed firm or flexible material layer dimensioned for the purpose of sealing a drain it is readily possible to obtain a reliable seal.

The invention relates to a method for sealing a drain of any dimension, form and depth in a floor of a sanitary space or other spaces. The invention further relates to the device for sealing a drain. The invention also relates to a firm or flexible material layer dimensioned for the purpose of sealing a drain and to a preprocessed firm or flexible material layer dimensioned for the purpose of sealing a drain. The invention also comprises a kit of parts, comprising at least one drain and at least one flexible or firm material layer dimensioned for the purpose of sealing the drain.

An increasing number of people wish to have in their bathroom, other sanitary space or other space such as living room or kitchen a draining channel instead of the classic drain with grating. In addition to aesthetic advantages, a draining channel has an improved drainage capacity, is easier to clean and is less susceptible to blockages. However, making watertight floors in sanitary spaces or other spaces in which a draining channel is arranged creates various problems. It is usual to arrange a water-sealing plastic material layer on the floor, in which a recess the size of the drain is made. The water-resistant layer thus extends to the edge of the drain, after which a water-resistant sealant is then arranged in the gap between the edge of the drain and the water-sealing layer. Tiles can for instance then be arranged on the water-sealing layer.

A drawback of the known method is that the periphery of the channel is relatively large and there is a high risk of there being a fault, or of one occurring over time, at one or more locations in the seal. The seal between the channel and the watertight material layer with the known types of sealant have frequently been found to be insufficient after a period of time, so that moisture can seep through the sealant and there result in leakage and fungal growth.

It is an object of the invention to make possible improved water-resistant sealing of drains in spaces, preferably in sanitary spaces.

The invention provides for this purpose a method for sealing a drain in a floor of a space, preferably a sanitary space, comprising of providing a floor provided with a drain, providing a watertight material layer, the dimensions of which are greater than a periphery of the drain, arranging the material layer on the floor, wherein at least the drain is covered, wherein flaps formed from the material layer form a recess in the material layer which is dimensioned for the periphery of the drain, wherein the flaps connect to an inner surface of the drain. In this way the watertight material is arranged such that water is guided over the flaps into the drain, thereby minimizing the chance of leakage at the transition from watertight material to drain. The floor can be manufactured from any conceivable material, including cement, concrete and/or wood. The floor surface is preferably evened out, sloping downward in the direction of the channel. The drain is preferably a channel which is concealed in a recess in the floor, wherein an edge of the channel connects to the surface of the floor. A drain is generally manufactured from metal or plastic and provided with connecting means for drainage of water to a sewer. The drain can have an elongate, square, round, trapezoidal, or, in short, any geometrical form, optionally with a curve or bend. The material layer can be manufactured from firm as well as flexible material, or a combination thereof. Firm materials can for instance be obtained by casting plastic or metal into a mould, or by curing a flexible material layer. Suitable firm materials are for instance polyvinylchloride (PVC), polyethylene (PE), polypropylene (PP), or polyester synthetic resins, polyconcrete, acryl, quaryl and porcelain.

The material layer is preferably a flexible material layer, wherein the flaps can be folded out of the material layer. A flexible material layer is exceptionally simple to arrange and adjust to irregularities in the floor. The flaps can be pre-formed, although they can also be formed from the material layer on site, for instance by making incisions. The flexible watertight material layer is preferably manufactured from a watertight plastic or assembly of plastic layers, such as polyvinylchloride (PVC), polyethylene (PE), polypropylene (PP) or polyester. These materials result in suitable watertight flexible layers when they are processed to a relatively thin layer or web. Special materials which are particularly suitable for sanitary fittings, such as fibre-reinforced polyethylene, are sold under brand names such as Schlüter-KERDI. The flaps can have different shapes, but are preferably trapezoidal. The flaps preferably engage on the channel from different sides. After being arranged in the channel the material layer can be further concealed, for instance by arranging decorative tiles.

In a preferred embodiment the flaps are connected to the inner surface of the drain. This creates a watertight sealing. The connection can take place with any conceivable type of connecting means. Watertight connection can for instance be realized by arranging an adhesive strip or a sealant.

It is recommended that the connecting of the flaps to the inner surface of the drain is brought about by adhesion. Various types of adhesive are suitable for a watertight connection of the flaps to the channel: the choice depends on the types of material used for both the watertight material layer and the inner surface of the channel. It is possible to envisage applying the adhesive to the side of the flaps directed toward the channel prior to folding down the flaps.

In a preferred embodiment the drain forms substantially an elongate channel, wherein four flaps are formed from the material layer, wherein two opposite flaps are connected to the longitudinal sides of the inner surface and wherein two other opposite flaps are connected to the end surfaces of the elongate channel. A reliable sealing is thus created.

It is advantageous if the flaps are formed by arranging two connecting Y-shaped incisions in the material layer. Flaps are thus formed with a maximum surface area, and minimum material loss is also achieved.

In a preferred embodiment the incisions to be arranged are marked on the flexible material layer prior to forming of the flaps. It is thus easy to arrange the desired form. The flaps can for instance be marked out using a template dimensioned for the dimensions of the drain, or using the drain itself.

After arranging of the flaps the channel is preferably covered with a grating. Such a grating can be used to fix the water-sealing material layer by way of clamping fit.

The invention also provides a device for sealing a drain by means of the method according to the invention, comprising cutting means for cutting flaps in a flexible material layer, pressing means connected to the cutting means and adapted to fold down the flaps cut out of the material layer and to press the flaps against an inner side of a drain, wherein the cutting means and the pressing means are dimensioned for the drain.

It is exceptionally easy to perform the method according to the invention using such a device. The cutting means can comprise a knife or a punch having the desired cutting form or being displaceable along the desired cutting edges. The pressing means can comprise simple displaceable pressing elements.

In a preferred embodiment the device is provided with a locating edge for positioning the cutting means and the pressing means on the material layer relative to the drain. It is thus particularly simple to position the device correctly relative to the edge of the channel.

In a preferred embodiment the cutting means are connected telescopically to the pressing means, wherein the cutting means are situated inside the pressing means such that, when the device is operated, the cutting means are first displaced and then the pressing means. Thus created is a particularly simple device which makes it possible to perform multiple method steps of the method in one linear movement of the cutting means and pressing means connected telescopically to each other.

The invention further provides a flexible material layer dimensioned for sealing a drain, characterized in that cutting lines are marked on the material layer for flaps dimensioned for at least one type of drain. It is thus easy to make a seal according to the invention from the material layer. The incision can be made using any known cutting tool, such as a Stanley knife.

In a preferred embodiment cutting lines are marked on the material layer for different types of drain of differing dimensions. The material layer can thus be used for different sorts and types of channel, so that is not necessary to stock material layers marked for each different type of channel. The cutting lines for different channels can for instance be arranged using different patterns and/or different colours, so that the incisions for different channels can be readily distinguished.

The invention also provides a preprocessed material layer dimensioned for sealing a drain, characterized in that flaps dimensioned for connecting to an inner surface of a drain are formed from the material layer. The material layer can be preformed from a firm material, but is preferably manufactured from a flexible material. It is thus not necessary for a fitter to carry out the potentially dangerous cutting or forming of the flaps himself, wherein material loss can also occur when errors are made during cutting. The cut parts can for instance be punched out in a factory using a high-quality punch, or be cast or folded from a curing, firm material using a mould.

The invention also comprises a kit of parts, comprising at least one drain and at least one material layer dimensioned for sealing the drain. It is hereby easy to perform the method according to the invention. The flaps can already be marked, cut out or formed on the material layer. The material layer can be preformed from a firm material, but is preferably manufactured from a flexible material. It is also possible to envisage the kit comprising aids such as a cutting tool for forming the flaps or an adhesive suitable for connecting the material layer to the drain. It is particularly advantageous when the kit comprises a device according to the invention for performing the method according to the invention.

The invention will now be elucidated on the basis of the following embodiments.

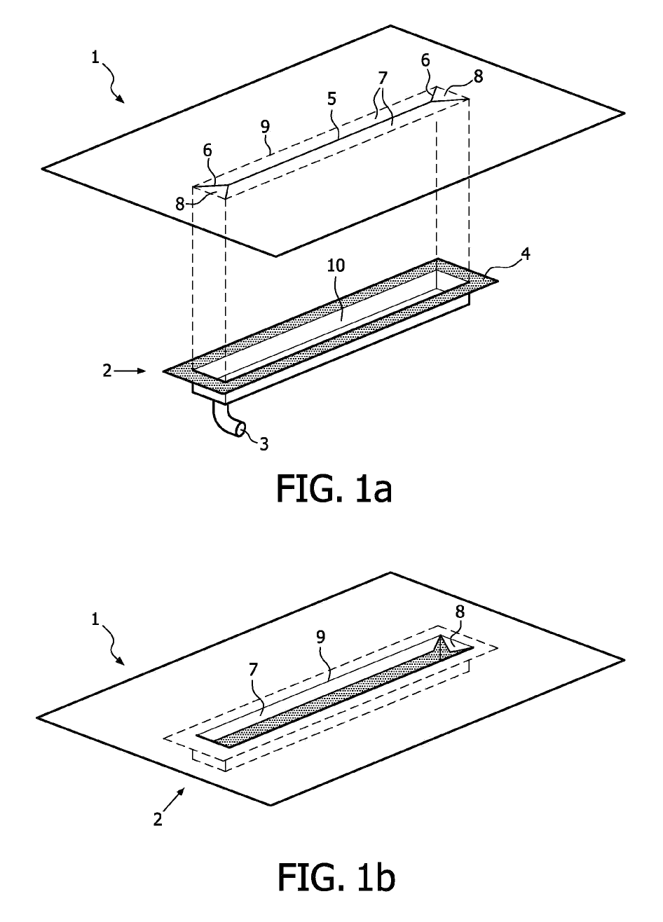

FIGS. 1a and 1b show the principle of the method according to the invention.

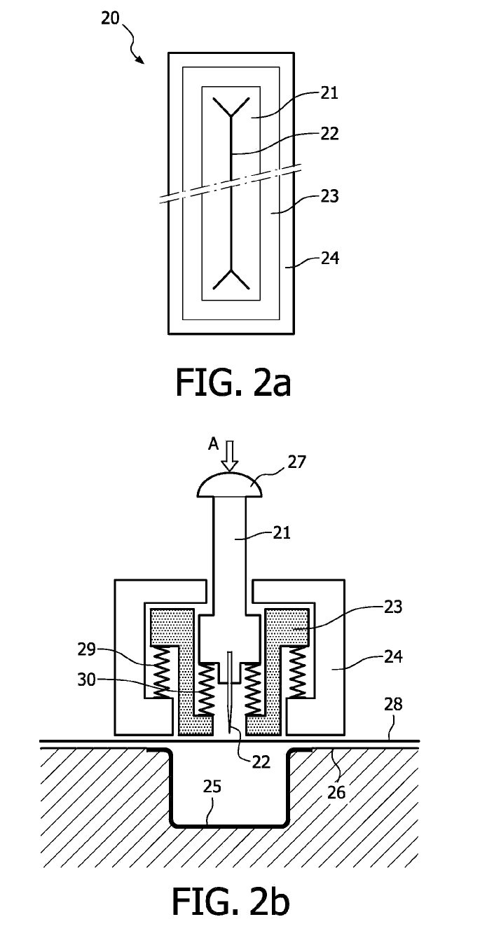

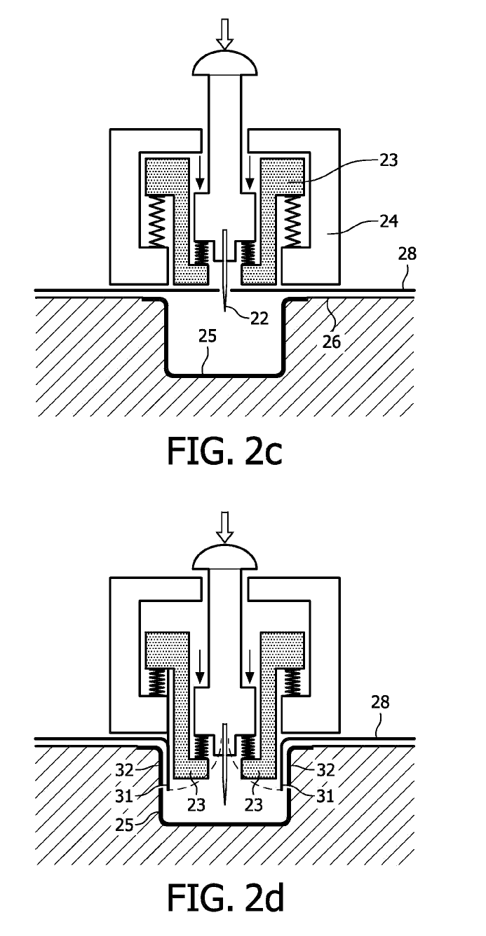

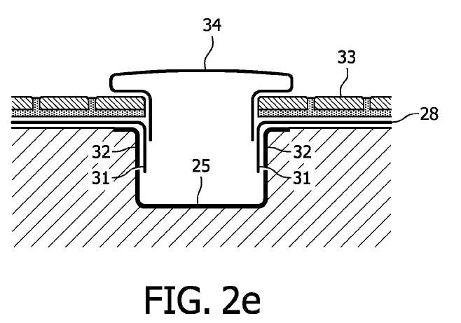

FIGS. 2a-2e show the method according to the invention using a device which facilitates the method.

FIG. 1a shows a piece of watertight material 1 and a drain 2 which can for instance be installed in the floor of a bathroom or shower space. Drain 2 is provided with connecting means for a waste pipe 3 and with edges 4 for positioning channel 2 on a floor (not shown). Such channels 2 can be embodied in diverse dimensions and sizes, for instance from metal and/or plastic, and increase the design freedom in respect of the drain.

Watertight material layer 1 covers a larger floor area than channel 2. The watertight material can consist of any sealing material suitable for sanitary applications. Arranged on material layer 1 are markings 5, which indicate the incisions to be made according to the invention and which are dimensioned for drain 2. It is possible to envisage arranging on one material layer markings dimensioned for the sizes of different types of channel 2 (preferably in different colours) so that the same material layer can be readily applied in combination with different channels. A user can use the pre-arranged lines 5 associated with the relevant channel 2 in order to arrange the desired incision, for instance with a knife. In another preferred embodiment it is possible to envisage a pre-made incision already being arranged instead of markings 5, so that the user does not have to use any potentially dangerous cutting tools. The incision is elongate, in the longitudinal direction of the channel, and has Y-shaped incisions 6 at the outer ends, whereby two relatively large flaps 7 are formed on the longitudinal sides and two relatively small flaps 8 on the end surface of the incision. Broken lines 9 indicate the fold lines.

In FIG. 1b the water-sealing material layer 1 is attached to channel 2 by adhering flaps 7, 8 to the inner side 10 of channel 2 after these flaps 7, 8 have been cut out. Owing to this attachment water on the water-sealing mat 1 will be guided to the channel, wherein the danger of water leaking between channel 2 and water-sealing layer 1 is minimized in that the guiding continues into the channel. In prior art sealing the water-sealing layer 1 runs up to the edge of channel 2, and the transition from water-sealing layer 1 to channel 2 is further finished using a sealant. It has however been found that the chance of leakage, and thereby also the chance of unhygienic situations resulting from fungi and the like, is minimized with a sealing according to the invention. It is otherwise also possible to envisage forming the water-sealing material layer 1 from a firm material prior to arranging thereof, for instance by casting plastic to the size of the channel 2 in question. Another option for obtaining a seal of a firm material is by making a plastic material flexible by heating, giving this material the desired shape (preforming), and subsequently fixing the desired shape by cooling. Yet another method is to give a flexible material the correct shape and to fix the material in the desired shape through a chemical reaction (cross-linking or polymerization), for which purpose various suitable synthetic resins are available.

It is optionally advantageous to also form from the same material layer 1 an upright edge which can be arranged connecting to a wall so as to thus bring about a complete sealing in simple manner. The upright edge can for instance be arranged by adhering to the vertical wall, and preferably extends 10 cm from the horizontal plane of the sealing material. For flexible material layers 1 the upright edge can be formed in simple manner by folding, for firm material layers 1 the upright edge can be preformed.

FIGS. 2a-2e show the operation of a device 20 according to the invention. FIG. 2a shows a bottom view, dimensioned for a determined type of channel. The components are further elucidated in the cross-section according to FIG. 2b. There are three parts connected telescopically to each other. The cutting part 21 located furthest inward is provided with a knife 22 in the desired cutting form as described in FIG. 1a. Pressing part 23 forms a movable edge which is dimensioned to fit at least partially in channel 25, and the support part 24 located furthest outward is dimensioned to support on the edge 26 round the channel. Cutting part 22 is also provided with an operating member 27 which can be pressed in as according to arrow A so that knife 22 cuts through a material layer 28 arranged on floor 26. The parts (21, 23, 24) are mutually connected via springs 29, 30 which urge the parts into the rest position shown in FIG. 2b.

The spring constant between cutting part 21 and pressing part 23 is smaller than the spring constant between pressing part 23 and support part 24 so that, when pressed in, only cutting part 21 will in the first instance be displaced, resulting in the situation of FIG. 2c, in which the flaps are cut out by knife 22.

As shown in FIG. 2d, pressing part 23 pushes the formed flaps 31 against side walls 32 of drain 25. An adhesive layer can be applied between flaps 31 and side walls 25, whereby flaps 31 are fixed. FIG. 2e shows the final situation, in which a layer of tiles 33 is arranged on water-sealing layer 28 and a grating 34 is fixed onto the channel. Water can thus be guided into the channel via the grating, wherein the flaps guide the water into the channel and thus prevent leakages.

In addition to the flaps connecting to the drain, it is also advantageous to form upright edges from the same firm or flexible material layer for the purpose of forming an upright water-sealing edge against the side walls of the space for sealing. In the case of a flexible material this can be done by folding on site, in the case of a firm material the upright edge can be preformed, or in the case of a thermoplastic material be formed on site by being heating. The upright edge is preferably at least 10 cm high as measured from the horizontal plane.

1. Method for sealing a drain in a floor of a space, preferably a sanitary space, comprising of
providing a floor provided with a drain,
providing a watertight material layer, the dimensions of which are greater than a periphery of the drain,
arranging the material layer on the floor, wherein at least the drain is covered, wherein flaps formed from the material layer form a recess in the material layer which is dimensioned for the periphery of the drain, wherein the flaps connect to an inner surface of the drain.

2. Method as claimed in claim 1, characterized in that the material layer is a flexible material layer, wherein the flaps can be folded out of the material layer.

3. Method as claimed in claim 1, characterized in that the flaps are connected to the inner surface of the drain.

4. Method as claimed in claim 3, characterized in that the connecting of the flaps to the inner surface of the drain is brought about by adhesion.

5. Method as claimed in claim 1, characterized in that the drain forms substantially an elongate channel, wherein four flaps are formed from the material layer, wherein two opposite flaps are connected to the longitudinal sides of the inner surface and wherein two other opposite flaps are connected to the end surfaces of the elongate channel.

6. Method as claimed in claim 1, characterized in that the flaps are formed by arranging two connecting Y-shaped incisions in the material layer.

7. Method as claimed in claim 1, characterized in that the incisions to be arranged are marked on the flexible material layer prior to forming of the flaps.

8. Method as claimed in claim 1, characterized in that after arranging of the flaps the channel is covered with a grating.

9. Device for sealing a drain by means of the method as claimed in claim 1, comprising
cutting means for cutting flaps in a flexible material layer,
pressing means connected to the cutting means and adapted to fold out the flaps cut out of the material layer and to press the flaps against an inner side of a drain,
wherein the cutting means and the pressing means are dimensioned for the drain.

10. Device as claimed in claim 9, characterized in that the device is provided with a locating edge for positioning the cutting means and the pressing means on the material layer relative to the drain.

11. Device as claimed in claim 9, characterized in that the cutting means are connected telescopically to the pressing means, wherein the cutting means are situated inside the pressing means such that, when the device is operated, the cutting means are first displaced and then the pressing means.

12. Flexible material layer dimensioned for sealing a drain, characterized in that cutting lines are marked on the material layer for flaps dimensioned for at least one type of drain.

13. Flexible material layer as claimed in claim 12, characterized in that cutting lines are marked on the material layer for different types of drain of differing dimensions.

14. Preprocessed material layer dimensioned for sealing a drain, characterized in that flaps dimensioned for connecting to an inner surface of a drain are formed from the material layer.

15. Kit of parts, comprising at least one drain and at least one material layer dimensioned for sealing the drain.
